(19) United States
(12) Patent Application Publication
(10) Pub. No.: US 2003/0194204 A1
(43) Pub. Date: Oct. 16, 2003

(54) Image recording apparatus capable of updating driving program using a portable recording medium

(75) Inventors: Iizuka Hiroshi, Suwon-City (KR); Oguro Masaki, Suwon-City (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRONICS CO., LTD., Suwon-City (KR)

(21) Appl. No.: 10/412,245

(22) Filed: Apr. 14, 2003

(30) Foreign Application Priority Data
Apr. 16, 2002 (KR) 2002-20537

(51) Int. Cl. H04N 5/76; H04N 5/225; G11B 27/00

(52) U.S. Cl. 386/46; 386/117

(57) ABSTRACT

An image recording apparatus is capable of updating a driving program by using a portable storage medium. The image recording apparatus includes a shooting unit shooting and taking images of an object, a recording unit recording the images of the object taken by the shooting unit, a communication module capable of mutually communicating with an external communication terminal, a reading unit removably connectible to an external storage medium that stores a driving program enabling the mutual communication between the communication module and the external communication terminal, the reading unit reading the driving program from the external storage medium, a control unit controlling the communication module based on the driving program read by the reading unit, wherein the communication module performs the mutual communication with the external communication terminal and a storage unit storing the driving program read by the reading unit from the external recording medium. The control unit controls the communication module to perform the mutual communication with the communication terminal using the driving program stored in the storage unit. As a result, addition and deletion of function of the image recording apparatus becomes possible even after the assembling process.

### CROSS-REFERENCE TO RELATED APPLICATIONS

This application claims the benefit of Korean Application No. 2002-20537, filed Apr. 16, 2002, in the Korean Intellectual Property Office, the Disclosure of which is incorporated herein by reference.

### BACKGROUND OF THE INVENTION

1. Field of the Invention

The present invention generally relates to an image recording apparatus such as a digital camcorder, and more particularly, it relates to an image recording apparatus capable of updating driving software driving an external or internal communication module such as a Bluetooth module by using a portable recording medium.

2. Description of the Related Art

Generally, a digital camcorder has the function of a video camera that shoots an object and of a video recorder that records the image of the object. An operator of such a digital camcorder can shoot and take images of an object and record the taken images on a recording medium such as a magnetic tape and a memory stick. Further, the operator can check the images of the object by reproducing the images from the recording medium. Such reproduced images are displayed through a liquid crystal display or a view finder attached to the digital camcorder. The reproduced images can also be checked by connecting the digital camcorder with external display devices such as a television. The advantage of the digital camcorder is that it is a portable image shooting device that is easy to use and can shoot a desired object in any place, namely, outside, at a concert, etc.

The digital camcorder is assembled with all the required modules for respective functions being mounted in the digital camcorder, with a memory containing driving programs therein driving the modules mounted in the camcorder. Accordingly, the functions of the respective modules are limited to the functions stored in the memory at the time of the initial assembling process of the digital camcorder. In other words, no additions or deletions of the functions are allowed once the camcorder is assembled. A digital camcorder having a remote wireless communication function will be taken as an example to explain this more clearly. The digital camcorder having the remote wireless communication function is mounted with a Bluetooth module, which is the remote wireless communication module. Further, driving software, which drives the Bluetooth module so as to enable remote wireless communication, is stored in the built-in memory. For example, firmware, a profile, an application program interface (API) and an application can be stored in the memory as driving software.

Generally, the driving programs being installed at the time of assembling the digital camcorder are compatible and are interoperable with the other existing products. The problem is that the digital camcorder assembled as above is often incompatible with the new products to be manufactured. For example, a digital camcorder that is designed with a driving program to communicate with a wireless terminal at 10 meters cannot communicate with newer wireless technology that provides the ability to communicate with the wireless terminal at a distance of 100 m.

### SUMMARY OF THE INVENTION

Accordingly, it is an aspect of the present invention to provide a digital camcorder capable of expanding and modifying pre-programmed functions after the assembling of the digital camcorder in which a module and a driving program for the module are installed in the digital camcorder.

The above and/or other aspects are accomplished by an image recording apparatus according to the present invention, which includes a shooting unit shooting and taking images of an object, a recording unit recording the images of the object taken by the shooting unit, a communication module capable of mutually communicating (i.e., transmit and receive data) with an external communication terminal, a reading unit removably connectible to an external storage medium that stores a driving program performing the mutual communication between the communication module and the external communication terminal, the reading unit reading the driving program from the external storage medium, and a control unit controlling the communication module based on the driving program read by the reading unit, wherein the communication module performs the mutual communication with the external communication terminal.

Further provided is a storage unit storing the driving program read by the reading unit from the external recording medium. Accordingly, the control unit controls the communication module to perform the mutual communication with the communication terminal using the driving program stored in the storage unit. Also, the recording unit stores predetermined data on an internal storage medium that is received from the external communication terminal to the communication module. The internal storage medium may be a magnetic tape.

The communication module is a wireless communication module providing mutual wireless communications. Further, the wireless communication module is a remote wireless communication module providing mutual wireless communications. In one implementation, the remote wireless communication module is a bluetooth module.

The external storage medium may be a portable recording medium. The portable storage medium may employ a smart media card or a memory stick.

In another implementation, the image recording apparatus is a digital camcorder.

According to an aspect of the present invention, a driving program performing mutual communication with the external communication terminal through the bluetooth module may be stored in an external storage medium. As the need arises, the external storage medium is connected to the reading unit which reads the driving program. Accordingly, the mutual communication in this implementation is conducted with the external communication terminal through the bluetooth module based on such a read driving program. As a result, addition and deletion of the functions of the digital camcorder can be enabled easily even after the assembling of the digital camcorder.

### BRIEF DESCRIPTION OF THE DRAWINGS

The above and/or other aspects, features and other advantages of the present invention will be more clearly understood from the following detailed description taken in conjunction with the accompanying drawings, in which:

FIG. 1 is a block diagram showing a digital camcorder according to an embodiment of the present invention;

FIG. 2 is a block diagram showing an example of a reading unit of FIG. 1 in greater detail;

FIG. 3 is a block diagram showing a shooting unit of FIG. 1 in greater detail;

FIG. 4 is a block diagram showing a recording portion of FIG. 1; and

FIG. 5 is a block diagram showing an image converter and an input/output unit of FIG. 1 in greater detail.

### DETAILED DESCRIPTION

Reference will now be made in detail to embodiments of the present invention. Examples of the embodiments are also illustrated in the accompanying drawings, wherein like reference numerals refer to like elements throughout.

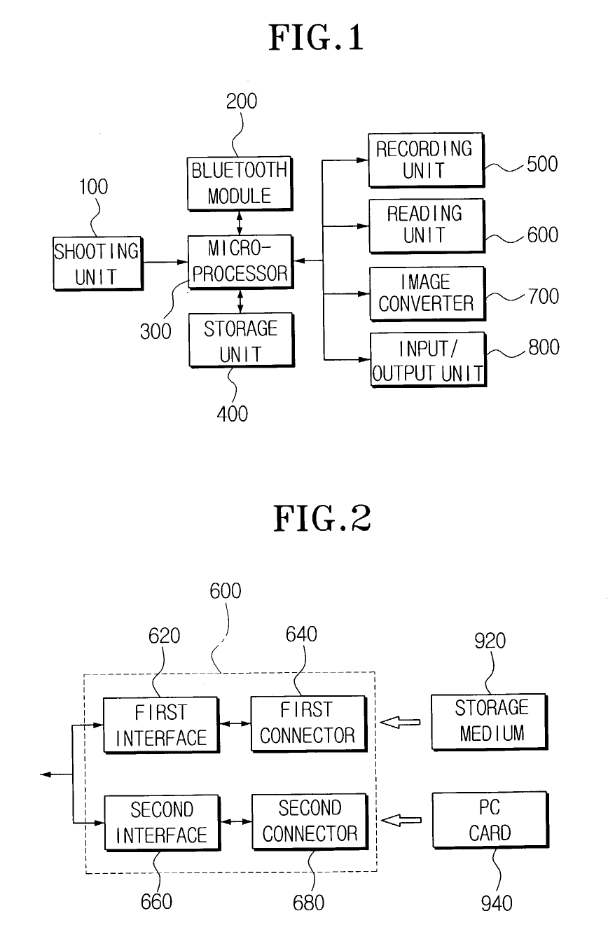

FIG. 1 is a block diagram showing a digital camcorder according to an embodiment of the present invention. As shown in FIG. 1, the digital camcorder includes a shooting unit 100, a microprocessor 300, a recording unit 500, an image converter 700 and an input/output unit 800.

The shooting unit 100 shoots and takes images of an object through a lens (not shown), and converts the taken images into a format recordable on a recording medium. The microprocessor 300 outputs the images taken by the shooting unit 100 to the recording unit 500. The recording unit 500 records the images on the recording medium such as a magnetic tape. The image converter 700 converts the taken images into a format displayable on an external display device (not shown) connected to the input/output unit 800. The input/output unit 800 outputs the images in the converted format from the image converter 700 to the external display device.

According to one embodiment of the present invention, the digital camcorder includes a bluetooth module 200, a reading unit 600 and a storage unit 400. The bluetooth module 200 performs mutual communication with the external remote wireless communication terminal in accordance with the control signal of the microprocessor 300. The reading unit 600 is removably connected to an external storage medium (not shown) that stores a driving program performing mutual communication between the bluetooth module 200 and the external communication terminal, and reads the driving program from the external storage medium. Examples of the external storage medium includes a memory stick, and a smart media card.

The reading unit 600 transmits the read driving program to the microprocessor 300. Accordingly, the microprocessor 300 controls the bluetooth module 200 to communicate with the external communication terminal based on the driving program transmitted from the reading unit 600. The storage unit 400 stores the driving program read from the reading unit 600 in accordance with the control signal of the microprocessor 300. Accordingly, the microprocessor 300 controls the bluetooth module 200 to communicate with the external communication terminal using the driving program stored in the storage unit 400.

As the bluetooth module 200 and the external communication terminal perform mutual communication therebetween, the recording unit 500 records the data received from the external communication terminal to the bluetooth module 200 on the recording medium, which may be, for example, a magnetic tape or a memory.

As described above, the driving program for the mutual communication with the external communication terminal through the bluetooth module 200 is stored in the external storage medium. Accordingly, as necessary, the storage medium is connected to the reading unit 600, and the driving program is read to control the bluetooth module 200. As a result, addition and deletion of functions in order to update the driving program after assembly of the digital camcorder becomes easier.

FIG. 2 is a block diagram showing an example of the reading unit 600 of FIG. 1 in greater detail. The reading unit 600 includes a first interface 620, a first connector 640, a second interface 660 and a second connector 680.

The first interface 620 reads the data from the storage medium 920 that is connected to the removable first connector 640 and transmits the read data to the microprocessor 300. According to one embodiment of the present invention, the first interface 620 reads the driving program operating the bluetooth module 200 from the storage medium 920 that is connected to the first connector 640. The second interface 660 receives the data from a PC card 940 of a computer (not shown) connected to the removable second connector 680.

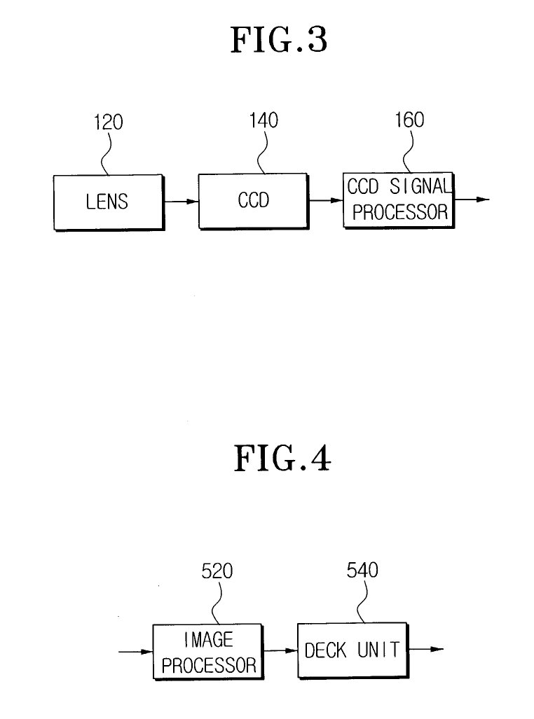

FIG. 3 is a block diagram showing the shooting unit 100 of FIG. 1 in greater detail. The shooting unit 100 includes a lens 120, a charge coupled device (CCD) 140 and a CCD signal processor 160. The lens 120 is for shooting, thus taking the images of the object. The CCD 140 accumulates the images of the object taken by the lens 120 and transmits the accumulated images. The CCD signal processor 160 converts the images provided from the CCD 140 into an electrical signal.

FIG. 4 is a block diagram schematically showing the recording unit 500 of FIG. 1. The recording unit 500 includes an image processor 520 and a deck unit 540. The image processor 520 converts the electrical signal converted at the CCD signal processor 160 into a format recordable on the recording medium. The deck unit 540 records the signal, which is converted to the recordable format, on the recording medium such as a magnetic tape inserted in the deck (not shown).

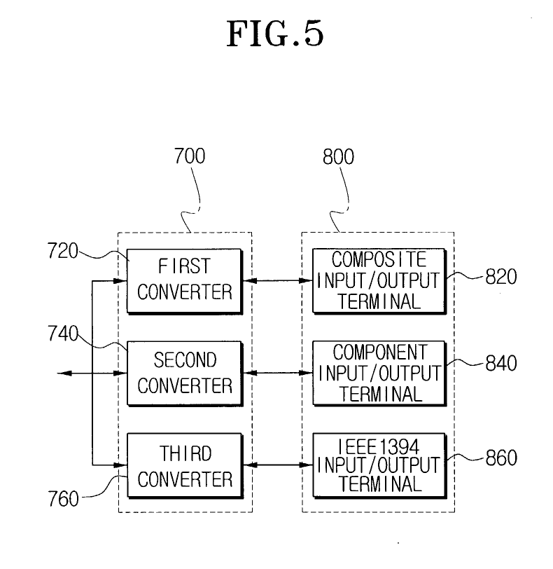

FIG. 5 is a block diagram showing the image converter 700 and the input/output unit 800 of FIG. 1 in greater detail. The image converter 700 includes a first converter 720, a second converter 740 and a third converter 760. The input/output unit 800 includes a composite input/output terminal 820, a component input/output terminal 840 and an IEEE 1394 input/output terminal 860. The first converter 720 converts the incoming image signals into composite signals outputted to the input/output terminal 820. The second converter 740 converts the incoming image signals into composite signals outputted to the component input/output terminal 840. The third converter 760 converts the incoming image signals into digital video signals outputted to the IEEE 1394 input/output terminal 860.

According to the present invention, a driving program conducting mutual communication with the external communication terminal through the bluetooth module is stored in an external storage medium. The external storage medium is connected to the reading unit which reads the driving program. Accordingly, the mutual communication is conducted with the external communication terminal through the bluetooth module based on such a read driving program. As a result, addition and deletion of the functions of the digital camcorder can be enabled easily even after the assembly of the digital camcorder.

The present invention has other embodiments. For example, the communication module may be another type of transceiver (transmits and receives analog or digital signals), such as, for example, a wireless LAN card or communication module that utilizes IEEE 802.11 protocols, an industrial, scientific, and medical (ISM) microwave band radio device, or a HomeRF communication device. The communication module or transceiver may be removed from the camcorder, such as, for example, the wireless LAN card mentioned above. Thus, a camcorder can be used in a “wireless mode” with the transceiver attached to the camcorder or as a conventional camcorder with the transceiver removed from the camcorder. In addition, a conventional camcorder may later be retrofitted with the transceiver. In a further implementation, the camcorder receives the driving program and/or the driving program update by a wireless connection between the transceiver and the wireless terminal.

Although embodiments of the present invention have been disclosed for illustrative purposes, those skilled in the art will appreciate that various modifications, additions and substitutions can be made without departing from the scope and spirit of the invention as disclosed in the accompanying claims.

What is claimed is:

1. An image recording apparatus, comprising:
a shooting unit shooting images of an object;
a recording unit recording the images of the object taken by the shooting unit;
a communication module mutually communicating with an external communication terminal;
a reading unit removably connectible to an external storage medium that stores a driving program performing the mutual communication between the communication module and the external communication terminal, the reading unit reading the driving program from the external storage medium; and
a control unit controlling the communication module based on the driving program read by the reading unit, wherein the communication module performs the mutual communication with the external communication terminal.

2. The image recording apparatus of claim 1, further comprising a storage unit storing the driving program read by the reading unit from the external recording medium, wherein the control unit controls the communication module to perform the mutual communication with the communication terminal using the driving program stored in the storage unit.

3. The image recording apparatus of claim 2, further comprising:
an internal storage medium,
wherein the recording unit stores predetermined data on the internal storage medium, the predetermined data being received by the communication module from the external communication terminal.

4. The image recording apparatus of claim 1, wherein the communication module comprises a wireless communication module.

5. The image recording apparatus of claim 1, wherein the external storage medium comprises a portable recording medium.

6. The image recording apparatus of claim 1, wherein the communication module comprises a removable communication module attached to or removed from the image recording apparatus.

7. A recording apparatus, comprising:
a video camera capturing images of a viewed object and recording the images;
a transceiver communicating with a remote wireless terminal;
an internal storage medium storing a driving program driving the transceiver, the driving program and/or driving program updates being received by the internal storage medium by downloading the driving program and/or the driving program updates from an external storage medium; and
a control unit controlling operation of the apparatus according to instructions provided by the driving program and/or the driving program updates.

8. A recording apparatus, comprising:
a video camera capturing images of a viewed object and recording the images;
a transceiver communicating with a remote wireless terminal;
an internal storage medium storing a driving program driving the transceiver, the driving program and/or driving program updates being received by the internal storage medium by downloading the driving program and/or the driving program updates from an external storage medium;
an image converter converting the images into a format displayable on a display device; and
an input/output unit connected to the image converter and connectible to the display device.

9. The apparatus of claim 8, wherein:
the image converter comprises:
a first converter converting the images into composite signals;
a second converter converting the images into composite signals; and
a third converter converting the images into digital video signals; and
the input/output unit comprises:
a composite input/output terminal connected to the first converter;
a component input/output terminal connected to the second converter; and
an IEEE 1394 input/output terminal connected to the third converter.

10. The recording apparatus of claim 8, further comprising:
an audio recording unit.

11. A method of controlling communication between a video camera and a remote wireless communications terminal, comprising:
connecting an external storage medium to the video camera;
downloading a driving program and/or a driving program update from the external storage medium; and
controlling the communication between the video camera and the remote wireless communications terminal according to instructions from the driving program and/or the driving program update.

12. A recording apparatus, comprising:
a video camera recording moving images;
a transceiver communicating with a wireless terminal; and
a driving program driving the transceiver, wherein the driving program is received and/or updated by connecting the recording apparatus to an external storage medium.

13. The recording apparatus of claim 12, wherein the transceiver comprises a removable transceiver that may be separated from the recording apparatus.
